(19) United States
(12) Patent Application Publication
(10) Pub. No.: US 2023/0146957 A1
(43) Pub. Date: May 11, 2023

(54) Outdoor Fire Suppression Spray System (Sky Hydrant ), and application

(71) Applicant: Randall Delgado, Pflugerville, TX (US)

(72) Inventor: Randall Delgado, Pflugerville, TX (US)

(21) Appl. No.: 17/520,609

(22) Filed: Nov. 5, 2021

(51) Int. Cl. A62C 37/36; A62C 35/68; A62C 3/02; E03B 9/02

(52) U.S. Cl. CPC A62C 37/04; A62C 3/0292; A62C 35/68; E03B 9/02

(57) ABSTRACT

The current invention is a remotely controlled fire suppression system that pipes water directly from a water main to a water cannon. The water can be sprayed hundreds of feet from the cannon, which can change direction and angle of spray. The suppression system is attached to a water main, with an electric valve that allows control of pressure and flow rate. The water cannon is attached at the top of the water pipe, which can rise 3′-30′ or more above the ground. The water cannon can be fixed or change direction and angle. The water valve and water cannon are remotely controlled, by wired or wireless communication. Units are identified by GPS and address, allowing individual or government units to use devices at fire sites.

### CROSS-REFERENCES TO RELATED APPLICATIONS (IF ANY)

None.

### BACKGROUND

### Field of the Invention

This invention relates to fire suppression spray and sprinkler systems, Sky Hydrant and particularly to outdoor systems that can be remotely controlled.

### Description of Prior Art

The device is aimed to reduce fire intensity and damage. Structural fires and wildland fires have very different fire behavior and temperature, but both can be slowed and/or reduced by a continual or intermittent spray of water and or other suppression agents.

By reducing the intensity and spread rate of a fire, responders will face less dangerous situations. This will also reduce the total damage by fires, reducing the cost to insurance companies, home owners, and municipalities.

There is still room for improvement in the art.

### SUMMARY OF THE INVENTION

The current invention is a Sky Hydrant, to be noted herein as “pole” with a spray nozzle device and system, that can be used to spray water and or other fire suppression agents at or near fires. The system attaches to water mains or other water source, and can be controlled remotely by wired or wireless systems. Each device has a GPS and address identity, to provide for its specific location and inclusion in the map of the overall fire suppression system. Individual devices could be owned or leased by private civilians or by government agencies. Each device could be controlled by a mobile computing device such as a cell phone or tablet which would include an application that can control the devices spray nozzle and other features. The apps would also provide administrative access and control.

The invention 1 consists of a pipe with a riser, water valve, communication cabinet, water cannon, and necessary hinges for desired movement. It can also include cameras and weather detecting monitors to help predict winds, temperature and other forecasts and observations.

The water pipe attaches to a water main below ground. The water pipe will be of various diameters. A riser water pipe is used to change the water pipe direction from horizontal to vertical. The water pipe will rise 3′-30′ or more above the ground in the preferred embodiemnt, depending on need.

The water valve is electrically controlled through the communication cabinet. The water valve is of various sizes based on need, but 2″- 4″ is typical.

The communication cabinet will house the desired communication hardware. This can be cellular, wired telemetry, or other technology, allowing for web or phone based access.

At the top of the pipe is the water cannon and other devices such as cameras and weather equipment. The water cannon can be of various sizes, with projector of 200′-500′ or more from the unit. The water cannon can be set in a fixed position or have complete movement of 360 degrees and thrust up/down. The cameras and weather equipment can vary in capability and features.

### BRIEF DESCRIPTION OF THE DRAWINGS

Without restricting the full scope of this invention, the preferred form of this invention is illustrated in the following drawings:

FIG. 1 shows the water cannon and components; and

FIG. 2 shows the water cannons in a grid to cover a whole neighborhood or area; and

FIG. 3 shows the water cannon connecting with a wireless device, but may be connected with wired telemetry or radio.

### DESCRIPTION OF THE PREFERRED EMBODIMENT

There are a number of significant design features and improvements incorporated within the invention.

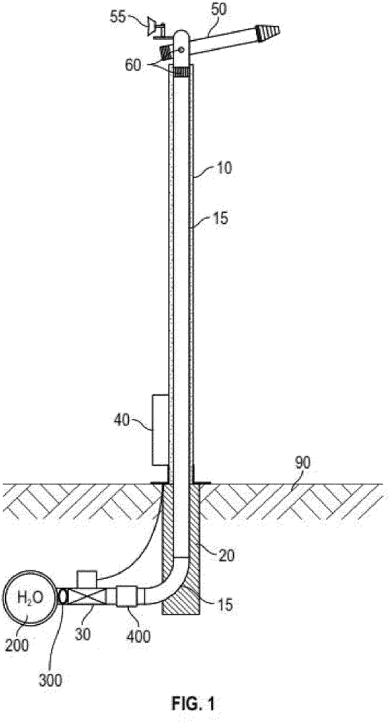

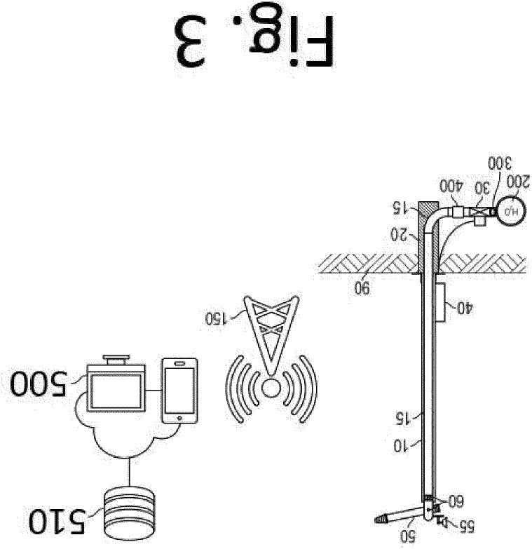

As shown in FIG. 1, the current invention is a pole 10 and foundation 20 and water pipe 15 with a spray nozzle 50 device and system, that can be used to spray water at or near fires. The system attaches to water mains 200 or other water source, and can be controlled remotely by wired or wireless systems FIG. 3, 150. The current invention is a web controlled fire suppression network for the primary protection of real properties with or without the use of onsite manpower.

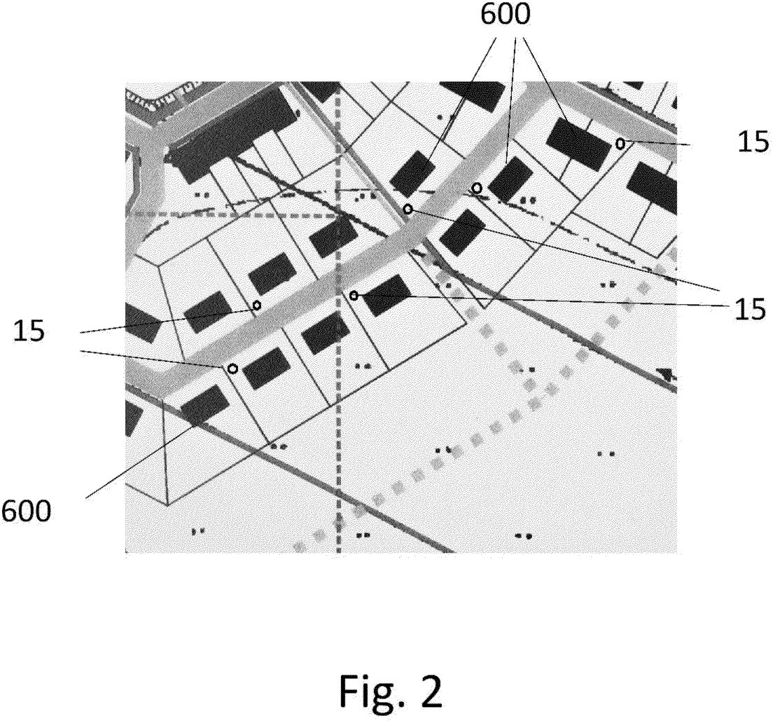

Each pole 10 location has a GPS and address identity, to provide for creation of maps of the overall fire suppression system as shown in FIG. 2. Individual poles 10 can be owned or leased by private civilians or by government agencies. The pole 10 units can be controlled in series, tandem or rotation dependent upon the ability of the water system and demands of the fire. The poles 10 will be properly placed and spaced out to protect the desired area such as buildings and homes 600.

The pole 10 consists of a foundation 20, water pipe 15, water valve 30, communication cabinet 40, water cannon 50, and necessary hinges 60 for desired movement.

The water pipe 15 attaches to a water main 200 below ground. The water pipe 15 will be of various diameters. The water pipe 15 changes from horizontal to vertical. The pole 10 and water pipe 15 will rise 3′-30′ above the ground 90, depending on need. At the top of the water pipe 15 is the water cannon 50. The water cannon 50 can be of various sizes, with projector of up to 500′ or more dependent upon water volume and pressure. The water cannon 50 can be set in a fixed position or have complete movement of 360 degrees and thrusts up/down.

The water valve 30 is electrically controlled through the communication cabinet 35. The water valve 30 is of various sizes based on need, but 2″-4″ is typical. The water valve 30 is used to open the flow of water and to set the volume and pressure of the water flow through the water pipe 15 and the water cannon 50. The water cannon 50 can be of various sizes and projector (typical projector of 200′-500′ or more radius each unit) depending on the needs of the location and water pressure. Booster pumps 300, may also be utilized if needed in low pressure areas where water volume is available. Backflow and agent injection devices 400 may also be included.

The communication cabinet 40, may be pole or ground mounted and will house the desired communication hardware. This can be cellular, wired telemetry, radio or other technology, allowing for web or phone based access. The communications cabinet 40 will control the water valve 30 and the direction and flow of the water cannon 50.

The poles 10 will be used to create a remote controlled fire suppression network that can be operated through remote devices 500 such as tablets and phones and via text messaging, and could be backed up with wired capability in the preferred embodiment.

As shown in FIG. 3, the system functionality will be accessed and managed with the most current and efficient available methods available, presently accessed from a user’s remote computing device 300 through a web browser over HTTP and/or HTTPS protocols or wireless network or cell phone to cell phone connection. The computing device 500, such as a cell phone, that can access the system 1 must have some version of a CPU, CPU memory, local hard disk, keyboard/keypad/input and display unit. The computing device 500 can be any desktop, laptop, tablet, smart phone or general purpose computing device with an appropriate amount of memory suitable for this purpose. Computing devices like this are well known in the art and are not pertinent to the invention.

The system, data and processing code can reside in the non-transitory, cloud based memory 510 of the one or more computing devices. The system in the preferred embodiment would be written to act like a smart phone application (app) where the different apps can communicate with each installation in the network. The system will be controlled by processing system with a program screen that will initiate by asking for the region, local and street address or other identifier (city, zip, address etc. ) as appropriate, to narrow and pin point the system availability. This is done utilizing a GPS mapping system the application will show the fire suppression network and identify the status of each, stand by, operating, out of service etc. After selecting the designated address or identifier, a drop menu will appear to allow selection of a plurality of actions such as: Operate valve, Operate Light, Operate a camera if available with Pan, Tilt and Zoom, etc. The processing system will have a controller administration to control each pole(s) in the system network of poles and set service status and or create subscription service status dependent upon each locations use arrangement i.e. private, municipal etc.

The program screen will initiate by asking for the region, local and street address or other identifier (city, zip, address etc. ) as appropriate, to narrow and pin point the system availability. The system will utilize a GPS mapping system, the application that shows the fire suppression network of poles 10, and identify the status of each such as stand by, operating, or out of service.

The system can utilize weather and wind data to operate in an automated mode to optimize location and duration of operation.

The system will allow the user to select a designated address or other identifier. The system will allow selection of the following actions: operate valve at the address, operate light (If available), operate camera (if available), pan tilt zoom and other system capabilities.

The system will have a controller administration function that will allow a user to add / delete a pole, to set service status and create sub user admin to allow field operation.

### Advantages

The innovative fire suppression system, Sky Hydrant allows fires to be slowed, reduced, or even extinguished with minimal aid of onsite firefighting personnel. Sprinkler systems can suppress fires within a building, but must be installed in each building. This invention allows fire suppression water cannons to be installed anywhere with access to pressurized water, and can be remotely controlled to spray water hundreds of feet. Water cannons can be equipped with lights and cameras to allow a remote user to see the fire that is being fought. This combination of traits will improve private or government users to remotely fight fires, which will increase response time, reduce overall damages and costs, and reduce manpower required and risks confronted by firefighting personnel.

Although the present invention has been described in considerable detail with reference to certain preferred versions thereof, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A fire suppression device comprising:
a plurality of poles with a pipe, a riser, water valve, water cannon and a plurality of hinges where the pipe is attached to the riser and to the water cannon and a water source, where the hinges control the direction of the water cannon, having the water valve control the water flow and having a communication cabinet.

2. The fire suppression device according to claim 1 further comprising:
where the pole is set into the ground.

3. The fire suppression device according to claim 1 further comprising:
having a control panel that controls the water valve.

4. The fire suppression device according to claim 1 further comprising:
having a control panel that controls the direction of the water cannon.

5. The fire suppression device according to claim 1 further comprising:
where a computing device communicates with the communication cabinet.

6. The fire suppression device according to claim 5 further comprising:
where the communication is wireless.

7. The fire suppression device according to claim 5 further comprising:
where the communication is to a computing device.

8. The fire suppression device according to claim 1 further comprising:
each pole having a GPS identity.

9. The fire suppression device according to claim 1 further comprising:
each pole having an address identity.

10. The fire suppression device according to claim 1 further comprising:
where a computing device controls one or more fire suppression devices.

11. A fire suppression system comprising:
having a plurality of fire suppression devices comprised of poles with a pipe, a riser, water valve, water cannon and a plurality of hinges where the pipe is attached to the riser and to the water cannon and a water source, where the hinges control the direction of the water cannon, and
having the water valve control the water flow and having a communication cabinet.

12. The system according to claim 11 further comprising:
where the pole is set into the ground.

13. The system according to claim 11 further comprising:
having a control panel that controls the water valve.

14. The system according to claim 11 further comprising:
having a control panel that controls the direction of the water cannon.

15. The system according to claim 11 further comprising:
where a computing device communicates with the communication cabinet.

16. The system according to claim 15 further comprising:
where the communication is wireless.

17. The system according to claim 15 further comprising:
where the communication is to a computing device.

18. The system according to claim 11 further comprising:
each pole having a GPS identity.

19. The system according to claim 11 further comprising:
each pole having an address identity.

20. The system according to claim 11 further comprising:
where a computing device controls one or more fire suppression devices.
